(19) United States
(12) Patent Application Publication
(10) Pub. No.: US 2017/0173781 A1
(43) Pub. Date: Jun. 22, 2017

(54) Double Lid for an Assortment Box

(71) Applicant: Raaco A/S, Nykøbing F (DK)

(72) Inventor: Peter-Thomas DAMBERG, Nykøbing Falster (DK)

(21) Appl. No.: 15/324,425

(22) PCT Filed: Jul. 9, 2015
(86) PCT No.: PCT/EP2015/065716

§ 371 Date: Jan. 6, 2017

(30) Foreign Application Priority Data
Jul. 9, 2014 (EP) 14176306.0

(51) Int. Cl. B25H 3/02; A45C 13/26; B65D 25/54; A45C 5/03; A45C 11/00; A45C 13/02

(52) U.S. Cl. CPC B25H 3/025; A45C 11/00; A45C 13/02; B65D 25/54; A45C 5/03; A45C 13/26

(57) ABSTRACT

The present invention relates to a container, such as a toolbox or an assortment box, wherein said container comprises a lower container part and an upper lid part, and wherein said upper lid part is for opening and closing access to said lower container part, said upper lid part comprising two adjacent layers with a mutual distance defining a lid cavity between said layers, said layers being respectively an upper lid surface layer and a lower lid surface layer, wherein the upper lid surface layer is connected to the lower lid surface layer in a releasable manner for accessing said lid cavity, and where at least the upper lid surface layer or lower lid surface layer comprises a transparent material, whereby content in said lid cavity becomes visible through at least said upper or lower lid surface layer.

The present invention relates to a container, such as a toolbox or an assortment box, wherein said container comprises a lower container part and an upper lid part and wherein said lid part is for opening and closing access to said container part.

For example, when doing carpentry or installing items, such as lamps, in your house, it is well known to make use of a toolbox or assortment box, containing e.g. screws, nails and bolts. Depending e.g. on whether you work professionally or you just install items in your spare time, and depending on the variety of e.g. screws, nails and bolts to be used, the toolbox or assortment box may have to contain several different parts. The difficulty in finding the correct part in the toolbox or assortment box will inevitably increase with the number of different parts.

To remedy the above disadvantage, various variants of toolboxes or assortment boxes have been proposed. Known solutions for reducing the difficulty in finding the correct part in the toolbox or assortment box include insertion of several small compartments in the toolbox or assortment box, e.g. one for each type of part, and one for each size of part. Depending on the number of different types and sizes of the parts, the user may have a hard time finding the correct part because a lot of compartments have to be looked through, and it may not be completely clear exactly which size the parts have.

DE 20 2012 101 277 U1 relates to a toolbox comprising a container, where said container comprises a container part and a lid part that may pivot relative to each other so that the container can be opened and closed. A locking part may lock the container part and lid part to each other. The lid part comprises a transparent window so that the user can see into the container, when the container is closed. DE 94 15 661 also relates to a toolbox. The toolbox comprises a container part and a lid part. The lid part comprises several small compartments for containing nails, screws etc. The small compartments are closed off from the surroundings by a transparent lid. Thus, the user can see the content of the small compartments, but not of the container part, when the transparent lid has been closed.

Known containers, such as toolboxes or assortment boxes, do not provide an arrangement for identifying the content in a container in an easy and simple manner, no matter how many different parts are present in the container.

In accordance with the invention, there is provided a container, such as a toolbox or an assortment box, wherein said container comprises a lower container part and an upper lid part and wherein said upper lid part is for opening and closing access to said lower container part, said upper lid part comprises two adjacent layers with a mutual distance defining a lid cavity between said layers, said layers being respectively an upper lid surface layer and a lower lid surface layer, wherein the upper lid surface layer is connected to the lower lid surface layer in a releasable manner for accessing said lid cavity, and where at least the upper lid surface layer or lower lid surface layer comprises a transparent material, whereby content in said lid cavity becomes visible through at least said upper or lower lid surface layer.

When making use of a container for storing e.g. screws, nails and bolts, or tools, such as an assortment box or toolbox, it is evident that providing an upper lid part for a lower container part may be an advantage as the contents in the container can thus be prevented from falling out. The content could fall out during transport of the container. However, providing an upper lid part can typically have the drawback that visibility into the container is greatly reduced, or at worst, completely eliminated. The user may thus be forced to remove the upper lid part to have visibility into the container and thereby identifying the content of the container.

Providing two adjacent layers with a mutual distance defining a lid cavity between said layers facilitates that the user can store an item in the lid cavity, e.g. instructions for the user as to the content of the container or for what is to be build/repaired, e.g. in the form of a paper document. Depending on whether the upper or the lower lid surface layer comprises a transparent material, the item can be seen from either the one or the other side of the upper lid part. If the item is directly related to the arrangement of the content in the container and is thus a table of content, it may be an advantage that at least the surface oriented towards the inside of the container comprises a transparent material, so that when the upper lid part is opened, the content can be quickly identified. On the other hand, if the instructions for the user is directed to the general content of the container, it may be an advantage that the instructions can be seen from at least the surface oriented towards the outside of the container.

Within the scope of the present invention, the term “item” to be stored in the lid cavity between the upper lid surface layer and lower lid surface layer may comprise all kinds of notes or illustrations providing the user with instructions and information as to e.g. what is the content of the container and where is it placed (table of content), how is it to be used, what can it be used for, where is it to be placed etc. The item may comprise various kinds of material such as paper, cardboard etc., which is suitable for being placed in the lid cavity. However, the item may also be e.g. a piece of vital tool or a screw or nail often used. Other variants of the type of item are foreseen within the scope of the invention.

Furthermore, the provision of two adjacent layers with a mutual distance defining a lid cavity between said adjacent layers may have the advantage that it is avoided that the item placed in the lid cavity is destroyed or manipulated unintentionally. In case said item is a piece of paper, the user is evidently not interested in liquid or fingers coming into contact with the item more than necessary as this could destroy the item completely or at best reduce the quality of the item. Moreover, the user avoids having to e.g. affix instructions to the upper lid part which could be difficult and time-consuming to remove again or replace, if wanted.

In an embodiment, both the upper and lower lid surface layers can comprise a transparent material, whereby content in said lid cavity becomes visible through both said upper and lower lid surface layers. If both surfaces are transparent, both the item placed in the lid cavity and the contents of the container can possibly be seen when the upper lid part is closing the container, obviously depending on the type and size of the item. Thus, the user can e.g. have a view of the contents of the container or see the item contained in the lid cavity, when the container is closed, but can also see the item, when the upper lid part is opened which may be important if the item comprises a table of content.

Thus, it is an aspect of the present invention to provide an easy and simple way of identifying the contents of a container.

In an embodiment, the upper lid surface layer and/or lower lid surface layer can be substantially plane. Depending on what type of item(s) is placed in the lid cavity, it may be an advantage that the upper lid surface layer and/or lower lid surface layer can be substantially plane. If the item is a piece of paper, at least one of said surface layers can be substantially plane so as to facilitate that the piece of paper is held substantially plane which may optimise the readability of e.g. text on the piece of paper. Having a substantially plane upper lid surface layer facilitates that the container can be e.g. stacked more easily with other similar containers or other boxes.

In an embodiment, the mutual distance between the upper lid surface layer and lower lid surface layer can be less than 40 mm, or less than 20 mm, or less than 5 mm, or the mutual distance can be 0.5 mm. The mutual distance between the upper and lower lid surface layer may be related to the size of the lid cavity. Generally, the larger the mutual distance, the larger the lid cavity. The necessary size of the mutual distance depends on the item to be placed in the lid cavity. If the item is a piece of tool, the lid cavity may be shaped according to the shape of the tool, for which reason the mutual distance e.g. may be 40 mm or less. If on the other hand the item is a screw or a manual, the lid cavity may be shaped according to the shape of the screw or the manual. Obviously, if the thickness of the item varies, e.g. along the longitudinal axis of the item, the shape of the lid cavity may be shaped accordingly. Furthermore, if the item to be contained in the lid cavity is e.g. 5 pieces of paper, the mutual distance between the upper and lower lid surface layer may be 0.5 mm. Thus, the upper and lower lid surface layers almost touch, but still define a lid cavity. If the lid cavity is shaped according to the shape of the item, the item contained in the lid cavity can be held steady and not move around, when the upper lid part is manipulated.

In an embodiment, the upper or lower lid surface layer can be structured, whereby two or more sub-cavities can be defined between said layers. Providing two or more subcavities may have the advantage that the upper and/or lower lid surface layers can be transparent for some of the sub-cavities and for others not. Thus, the upper lid part may be designed with partly or completely transparent sub-cavities according to the purpose of the container and according to the content of the container, e.g. according to which items e.g. instructions need to the visible for the user, when the container is opened or closed, respectively, and what content of the container needs to be visible, when the container is closed. Moreover, some sub-cavities can be transparent whereas others are not, and arranged this way such as to form a pattern.

Furthermore, the sub-cavities may be arranged such that the mutual distance between the upper and lower lid surface layers varies from sub-cavity to sub-cavity. The exact mutual distance may be chosen according to what item is arranged in the respective subcavity. If a wide item, such as a tool or a manual, is to be arranged in a sub-cavity, then the upper and lower lid surface layers may be arranged at a distance from each other at that exact sub-cavity which is larger than if only a thin item, such as one piece of paper, is to be arranged in a sub-cavity. Here, the upper and lower lid surface layers may be arranged close to each other, i.e. so that they almost touch each other.

In an embodiment, the two or more sub-cavities can be of similar shape and size. Depending on the content of the container, the lower container part may e.g. comprise two or more small container parts or another type of separation device so as to separate the content of the container according to size or type. Advantageously, the upper lid part may thus comprise two or more sub-cavities with similar shape and size, and the container part may comprise a corresponding separation, and a note or item identifying the content of each of the small containers may be inserted into the corresponding subcavity.

In an embodiment, the lid cavity can comprise a means for holding an item contained in the lid cavity. Providing a means for holding may be an advantage if the user wants to eliminate the risk of the item contained in the lid cavity accidentally being moved around, when the upper and lower lid surface layers are separated. In case the item is a table of contents, the user obviously does not want to risk the item being relocated as the table of content therefore does not identify the contents of the container any more. The means for holding may for example be, but is not limited to, an adhesive, a paper clip, a pocket or a sub-cavity of the sub-cavity.

In an embodiment, the upper lid surface layer can be pivotally connected to the lower lid surface layer. The possibility of the upper lid surface layer being pivotally connected to the lower lid surface layer facilitates easy separation of the upper from the lower lid surface layer. The user just has to rotate the upper lid surface layer relative to the lower lid surface layer. Afterwards, an item can easily be inserted into the space between said two surfaces, i.e. the lid cavity, and the upper and lower lid surface layers can easily be connected to each other again by way of simple rotation. Thus, there is minimal risk of e.g. accidentally moving the item when connecting said two layers again.

Furthermore, the upper lid surface layer being pivotally connected to the lower lid surface layer may result in a lifetime of several years for the container as pivoting may comprise e.g. just two parts rotating relative to each other thus avoiding e.g. severe tear and pressure which may obviously result in breakage or wearing down of said rotating parts.

The pivotal connection may e.g. comprise a protruding part and a corresponding receiving part, such as a hole, where the protruding and receiving parts can rotate free relative to each other. However, various variants of pivoting means are foreseen within the scope of the present invention.

In an embodiment, the upper lid surface layer can be connected to the lower lid surface layer by way of a means arranged for translation, such as sliding, of the upper lid surface layer relative to the lower lid surface layer, or vice versa. A means arranged for translation can e.g. be exemplified in the upper lid surface layer being able to translate/slide relative to the lower lid surface layer in a plane parallel to the plane of the lower lid surface layer. Thus, the user can easily translate the upper lid surface layer away from the lower lid surface layer, insert an item in the lid cavity, and translate the upper lid surface layer back to its initial position. The translation arrangement may comprise various types of means arranged for translation such as rails. The use of translation facilitates that the separation of the upper and lower lid surface layers may be carried out at places, where the user only has little room and thus little manoeuvrability. It is foreseen within the present invention that the means arranged for translation may comprise either a permanent or a temporary connection between the upper and lower lid surface layers.

In an embodiment, the upper lid part can be pivotally connected to the lower container part, and said connection between the upper lid part and the lower container part can be arranged adjacent to said connection between the upper and lower lid surface layer. The possibility of the upper lid part being pivotally connected to the lower container part may result in substantially similar advantages as explained for the pivotal connection between the upper and lower lid surface layers, i.e. an easy removal of the upper lid part from the lower container part by simply rotating the lid part relative to the lower container part thus opening to the container and an easy way of gathering the upper lid part and the lower container part again by simply rotating the upper lid part relative to the lower container part. Furthermore, there is no need for arranging the upper lid part correctly relative to the lower container part as the upper lid part is already oriented correctly via the pivotal connection. Moreover, the lifetime may be of several years as the pivotal connection between the upper lid part and the lower container part may comprise e.g. just two parts rotating relative to each other and thus, no severe tear and pressure takes place which may obviously result in breakage or wearing down of said rotating parts. A pivotal connection also provides a strong connection.

It is foreseen within the present invention that the pivotal connection between the upper lid part and the lower container part may be either permanent or momentary, i.e. that e.g. the pivotal connection can connect the upper lid part and the lower container part permanently, or that the upper lid part and the lower container part may be removed from each other completely, if wanted.

If arranging the connection between the upper lid part and the lower container part adjacent to said connection between the upper and lower lid surface layers, the upper lid part and respective upper and lower lid surface layers may function almost as pages of a book, i.e. both said connections may be arranged near/along the spine of the book. Arranging both said connections adjacent to each other has the advantage that the upper lid part and the upper and lower lid surface layers may easily be removed from the lower container part and from each other, respectively. When inserting an item in the upper lid cavity(-ies), the lid part simply has to be pivoted from the lower container part followed by the upper lid surface layer being pivoted from the lower lid surface layer, whereupon the item may be inserted. The upper lid part and/or the upper and lower lid surface layers do not necessarily have to be removed completely from either the lower container part or each other, respectively. In case the upper and lower lid surface layers are arranged e.g. as pages of a book as explained previously, the user has the possibility of inserting an item in the lid cavity, even if only little room is available, as the upper lid part only has to be removed slightly from the lower container part for the upper and lower lid surface layers to be parted and an item to be inserted.

Thus, it is an aspect of the present invention to provide a simple and low cost solution for inserting an item in the upper lid part of the container for helping the user to identify the content of the container.

In an embodiment, the upper and lower lid surface layers can comprise engagement means adapted to connect the upper and lower lid surface layers to each other. When an item has been inserted in the lid cavity, it should remain there and not be removed before it is intended to be removed. Thus, it is an advantage that the upper and lower lid surface layers are not separated unless intended. Engagement means may advantageously be placed e.g. between the upper and lower lid surface layers. The engagement means may e.g. comprise a protruding part placed on the lower lid surface layer and a receiving part placed on the upper lid surface layer, or vice versa, said protruding and receiving parts engaging each other when the upper and lower lid surface layers are connected. This could be exemplified by placing the protruding part at the edge of the lower lid surface layer thus extending away from the lower lid surface layer in a plane parallel to the plane of the lower lid surface layer. The corresponding receiving part may be placed in the upper lid surface layer and take the shape of a hole, closed or throughgoing, said hole extending parallel to the plane of the upper lid surface layer.

If the upper and lower lid surface layers can be pivoted relative to each other, the respective extension of engagement means may be substantially orthogonal to the movement of the upper and lower lid surface layers. The engagement means can thus function as locking means. Depending on the respective extension of the engagement means and thus the length of their overlap, they may obviously be disengaged by a firm pull if the overlap is minimal.

Thus, providing engagement means has the advantage that the upper and lower lid surface layers cannot be separated as a result of an accidental push or kick. Furthermore, applying more than one engagement means increases the effect of the engagement means, i.e. reduces the risk of the upper and lower lid surface layers accidentally separating, increases the stability of the engagement, and reduces the effect of the engagement means being worn down with time as not only one, but more than one engagement means have to become worn down/destroyed to result in a seriously reduced engagement. It is foreseen within the present invention that the engagement means may be either mounted on or produced as part of the upper and lower lid surface layers.

In an embodiment, the engagement means can comprise a recess part and a protruding part. Thus, in a very simple case, the engagement means may consist of a rod and a hole. Engagement means comprising a rod and a hole are known to be effective. Production of such engagement means can be easy and inexpensive as the template/mould for producing the upper lid part does not necessarily have to undergo considerable amendment to include the engagement means in case the engagement means is produced as part of the upper lid part. Consequently, repairing the engagement means also become easy as e.g. only a hole or a rod has to be considered.

In an embodiment, the upper and lower lid surface layers can comprise release means arranged for releasing the upper and lower lid surface layers from each other. Provision of release means has the advantage that the engagement means can be disengaged before the upper and lower lid surface layers are to be removed from each other. The release means can thus minimise the possible risk of wearing down the engagement means with time or even destroying the engagement means due to excessive stress. Obviously, the degree of wear on the engagement means varies with the specific type of engagement means. The engagement means may be designed disengage only with use of a release means.

Release means can also help the user to operate the upper lid part correctly as the release means can guide the user in disengaging the engagement means so that the upper and lower lid surface layers can be separated e.g. without having to apply force. If no release means is present, the user could potentially be in doubt about how to separate said two surface layers without destroying the engagement means. Some users may even have difficulty in separating said two surface layers if applying force is necessary.

Thus, it is an aspect of the present invention to provide a user-friendly and long-lasting solution.

In an embodiment, the release means can be pressure-activated. Various types of mechanisms may be provided as release means. Applicable solutions include, but are not limited to, clasps, or sliding, rotating or pressure-activated means. Provision of a pressure activated release means may result in a simple way of operation as the user simply has to press the release means, e.g. by use of a finger, in order to e.g. disengage the engagement means thus easing separation of the upper and lower lid surface layers.

The release means may be produced as an elongated member arranged at the upper and/or lower lid surface layer and may comprise one part of the engagement means, e.g. the protruding part. The other part of the upper and/or lower lid surface layer may comprise a corresponding second part of the engagement means, e.g. the recess part. When the upper and lower lid surface layers are connected and meet each other, the protruding and recess parts engage. When applying a pressure on the release means, the one part of the engagement means is being bent away from the second part of the engagement means which means that said two surface layers can easily be separated. Thus, a simple way of disengaging the engagement means is provided.

If the release means takes the form of an elongated member, the release means may in principle just be produced as a part of the upper and/or lower lid surface layer which may reduce the production expenses as the release means may e.g. be moulded simultaneously with the upper and/or lower lid surface layer. However, the release means may also be produced separately and afterwards be mounted on the upper and/or lower lid surface layer which may be a requirement if the upper and/or lower lid surface layer and the release means are not produced in the same material, e.g. if the upper and/or lower lid surface layer is produced in a plastic material and the release means is produced in metal or in a plastic material of a different composition than used in production of the upper and/or lower lid surface layer. Thus, the present invention provides an inexpensive and simple release mechanism.

In an embodiment, the container can be an assortment box for carrying tool assortment, such as nails, screws, electronic components or the like. By tool assortment is to be understood small items such as electronic components, tool components, bits, small tool devices as well as nails, screws etc. As explained previously, when for example doing carpentry or installing items, such as lamps, in your house, it is well known to make use of an assortment box containing e.g. screws, nails and bolts. Depending e.g. on whether you work professionally or you just install items in your spare time, and depending on the variety of e.g. screws, nails and bolts to be used, the assortment box may have to contain several different parts. The difficulty in finding the correct part in the assortment box will inevitably increase with the number of different parts. Thus, it can be an advantage that the upper lid part may comprise two adjacent layers (an upper and a lower lid surface layer) connected to each other, and wherein the upper and lower lid surface layers may either partly or completely comprise a transparent material. The content of the container can thus be visible when the upper lid part is open, and the previously described insertion of an item, e.g. a table of contents, in the lid cavity can thus identify the content of the container for the user, either when the upper lid part is closed or when it is open, or both. The item may e.g. also be instructions for the user on how to assemble or use the contents of the assortment box, or on how to repair or assemble an item by use of the contents of the assortment box.

The structure and function of the container and the method of using it will be described in more detail below with references to exemplary embodiments shown in the drawings wherein,

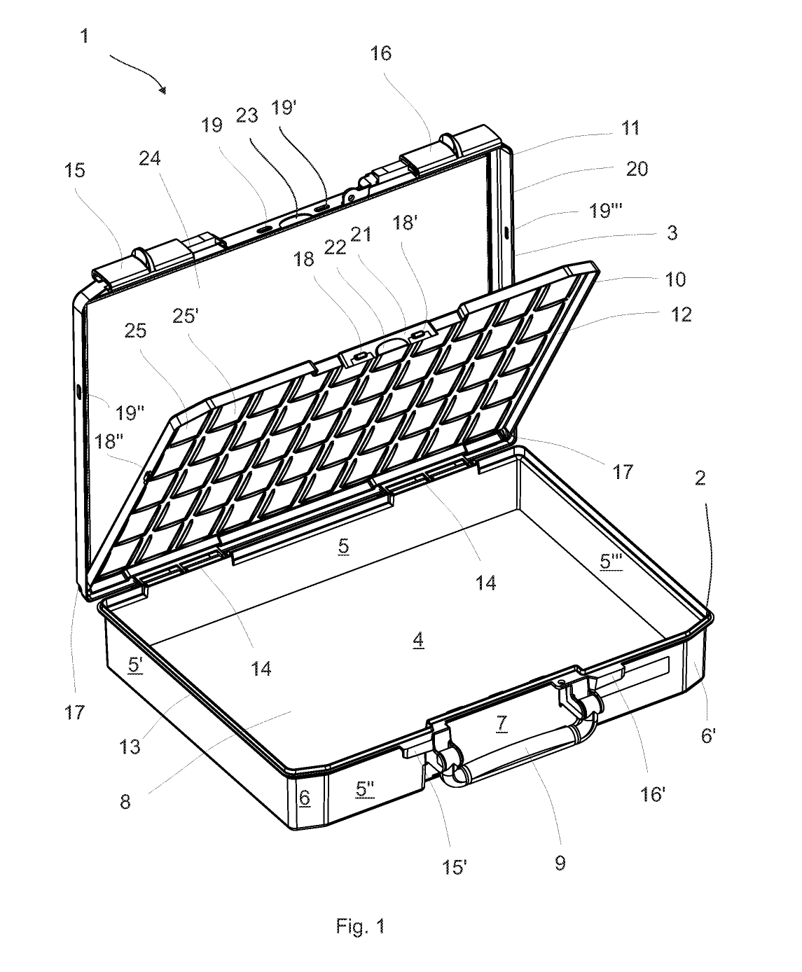

FIG. 1 shows one embodiment of a container in which the upper and lower lid surface layers are separated from each other, seen in a perspective view.

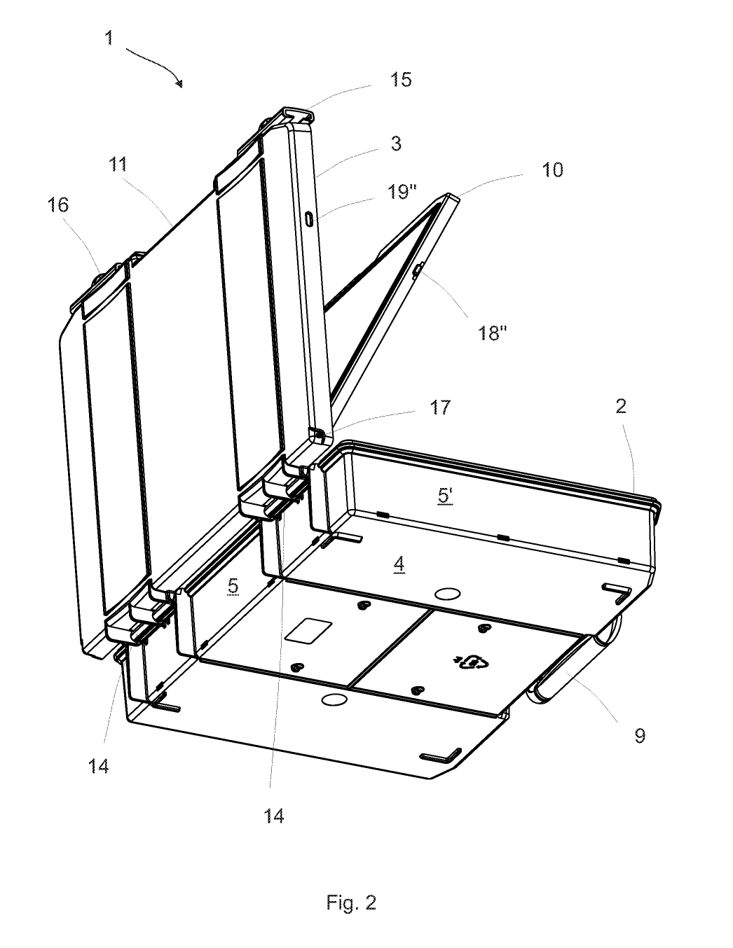

FIG. 2 shows one embodiment of a container in which the container is seen from below, in a perspective view.

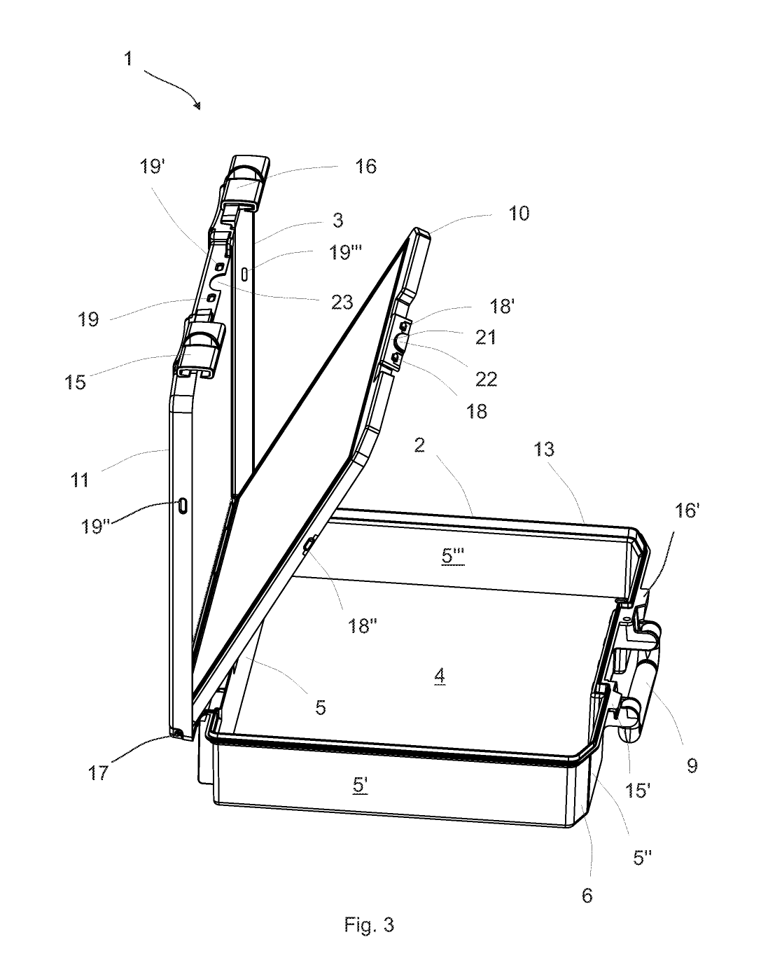

FIG. 3 shows one embodiment of a container seen from the side, in a perspective view.

In the figures, the container is shown having a rectangular cross section. However, it should be understood that other cross sections, such as circular, oval, square etc., are also intended within the scope of the present invention.

In the figures, the embodiments illustrate that the upper lid part may be for a toolbox or an assortment box. The person skilled in the art will understand that the illustrated combination of upper lid part and lower container part is not to be understood as exhaustive and that one kind of upper lid part may be used with several kinds of lower container parts comprising various types of contents, such as tools, nails, screws, spare parts, groceries etc.

FIG. 1 shows one embodiment of the present invention in which the upper and lower lid surface layers are separated, seen in a perspective view. The container 1 has been opened and is seen to comprise two parts, i.e. a lower container part 2 and an upper lid part 3.

The lower container part 2 is seen to have a substantially rectangular cross section and comprises a bottom part 4 and a first 5, second 5′, third 5″, and fourth side part 5″′ being substantially orthogonal to each other and to the bottom part 4. The third side part 5″ comprises two angled ends 6,6′ and a central part 7 protruding the inner opening 8 of the lower container part 2 thus defining a recess in the third side part 5″ arranged for comprising a handle 9 for the container 1.

The upper lid part 3 comprises a lower 10 and an upper lid surface layer 11. The periphery of the cross section of the lower 10 and upper lid surface layer 11 is seen to have substantially similar shape and size as the periphery of the cross section of the lower container part 2, such that an inner edge 12 of the lower lid surface layer 10 can engage an upper edge 13 of the lower container part 2 when the upper lid part 3 closes the opening of the lower container part 2. The upper lid part 3 may be pivotally connected to the container part 2 by use of a pivotal connection 14, such as hinges 14. When the container 1 is closed, i.e. the lower container part 2 and the upper lid part 3 engage each other, the container 1 may be locked by use of a first and second locking unit. Each of the locking units comprises a sliding part 15,16 and a holding part 15′,16. The sliding parts 15,16 may be slid over each their respective holding part 15′,16′ when the container 1 has been closed. Thus, the container 1 has been locked, and the lower container part 2 and upper lid part 3 cannot be separated before the first and second locking units have been unlocked again. Thus, the user can now pick up the container 1 by the handle 9 and transport the container 1 without there being any risk of the contents of the container 1 falling out.

The lower 10 and upper lid surface layers 11 may be pivotally connected to each other by use of a pivotal connection 17 and engagement means. The pivotal connection 17 may be fixed between the ends of two parallel edges of the lower 10 and the upper lid surface layer 11, whereby the lower 10 and upper lid surface layers 11 may be rotated relative to each other, such as with pages of a book.

The engagement means is illustrated in the exemplary embodiment of FIG. 1 as comprising a first, second, third and fourth engagement means, each comprising a protruding 18,18′,18″,18″′ and a receiving part 19,19′,19″,19″′. When pivoting the lower 10 and upper lid surface layers 11 towards each other, the protruding parts 18,18′,18″,18″′ of the first, second, third and fourth engagement means come into contact with the edge 20 of the upper lid surface layer 11. By applying a pressure on the lower lid surface layer 10, the protruding parts 18,18′,18″,18″′ will pass the edge 20 of the upper lid surface layer 11 and thus engage with the receiving parts 19,19′,19″,19″′ of the upper lid surface layer 11.

The lower lid surface layer 10 may comprise a release means 21 for releasing at least part of the engagement means and thus facilitate that already engaged lower 10 and upper lid surface layers 11 can be separated. The release means 21 may be arranged along an edge of the lower lid surface layer 10 and have an elongated shape. At least part of the engagement means, i.e. two of the protruding parts 18,18′ in the exemplary embodiment, may be mounted on or be produced as a part of the release means 21. The release means 21 may furthermore comprise an activation area 22 arranged for activating a release mechanism. The upper lid surface layer 11 may comprise a corresponding opening 23 for providing access to the activation area 22 when the lower 10 and upper lid surface layers 11 are engaged with each other. The release mechanism is carried out by a user pressing the activation area 22 e.g. with a finger thus moving the release means 21 and thus moving two of the protruding parts 18,18′ away from their corresponding receiving parts 19,19′. The lower lid surface layer 10 can now easily be separated from the upper lid surface layer 11. Obviously, it is foreseen within the present invention that the lower lid surface layer 10 may comprise the receiving parts 19,19′,19″,19″′ and that the upper lid surface layer 11 may comprise the protruding parts 18,18′,18″,18″′ of the engagement means.

The lower 10 and upper lid surface layers 11 define a lid cavity 24 in the space between them which is suitable for comprising an item (not shown). Depending on what the item is, the mutual distance between the lower 10 and upper lid surface layer 11 can vary. If the item is a table of contents, the mutual distance does not necessarily have to be more than the thickness of a piece of paper, and the mutual distance can thus be close to zero, or the lower 10 and upper lid surface layers 11 may even meet each other. If on the other hand, the item is an instruction book, a nail or a tool, the mutual distance has to be more than close to zero. In any case, the mutual distance can be slightly less than the thickness of the item so that the item can be kept at place by the pressure of the lower 10 and upper lid surface layers 11. In the exemplary embodiment of FIG. 1, the lower 10 and upper lid surface layers 11 comprise a transparent material so that the item can be seen both when the container 1 is open and closed and so that the user can see the contents of the container 1 when the container 1 is closed.

In the embodiment of FIG. 1, both the lower 10 and upper lid surface layers 11 are seen to be plane and define a lid cavity 24. However, the lower 10 and/or upper lid surface layer 11 may comprise several sub-cavities. The sub-cavities may thus each comprise a note identifying the contents of the lower container part 2 at the corresponding location in the lower container part 2. Small container units (not shown) may also be inserted in the lower container part 2 corresponding to the location of the sub-cavities so that the content of the lower container part 2 may be more precisely identified.

The inner surface 25 of the lower lid surface layer 10 may comprise several small areas 25′, so called U-profiles 25′, each of which bends slightly out from the lower lid surface layer 10. When the upper lid part 3 engages the lower container part 2, the upper lid part 3 and thus part of the U-profiles 25′ may come in close contact with the opening of the small containers, if inserted in the lower container part 2, which means that the items contained in the small containers will not escape the small containers even if the container 1 is moved around.

FIG. 2 shows one embodiment of a container 1 in which the container 1 is seen from below, in a perspective view. For similar parts, similar reference numbers have been used as in FIG. 1. In FIG. 2, the upper lid part 3 has been pivoted from the lower container part 2 so that the user has access to the inner opening 8 of the lower container part 2. The lower lid surface layer 10 has been separated from the upper lid surface layer 11 by the user pressing the release means 21 and pivoting the lower lid surface layer 10 away from the upper lid surface layer 11. Now, the user has free access to the lid cavity 24 defined by the lower 10 and upper lid surface layers 11 and may insert an item in the lid cavity 24. After insertion of an item in the lid cavity 24, the user can pivot the lower lid surface layer 10 relative to the upper lid surface layer 11 so that said adjacent layers 10,11 meet each other and press said surface layers 10,11 together. The protruding 18,18′,18″,18″′ and the receiving parts 19,19′,19″,19″′ of the engagement means then engage each other.

FIG. 3 shows one embodiment of a container 1 seen from the side in a perspective view. For similar parts, similar reference numbers have been used as in the previous figures. In FIG. 3, the upper lid part 3 has been pivoted relative to the lower container part 2 so that the user has access to the inner opening 8 of the lower container part 2. The lower lid surface layer 10 has been pivoted relative to the upper lid surface layer 11. Now, the user may insert an item, such as a table of contents, in the lid cavity 24 defined by the lower 10 and upper lid surface layer 11.

Modifications and combinations of the above principles and designs are foreseen within the scope of the present invention.

1. A container, such as a toolbox or an assortment box, wherein said container comprises a lower container part and an upper lid part and wherein said upper lid part is for opening and closing access to said lower container part, where said upper lid part comprises two adjacent layers with a mutual distance defining a lid cavity between said layers, said layers being respectively an upper lid surface layer and a lower lid surface layer, wherein the upper lid surface layer is connected to the lower lid surface layer in a releasable manner for accessing said lid cavity, and where both the upper lid surface layer and lower lid surface layer comprises a transparent material, whereby content in said lid cavity becomes visible through both said upper and lower lid surface layers, characterised in that said container is adapted to store small containers, where an inner surface of the lower lid surface layer comprises several small areas, so-called U-profiles, each bending slightly out from said lower lid surface layer, and where part of said U-profiles are adapted to come in close contact with an opening of said small containers stored in the lower container part, when the upper lid part engages the lower container part, so that items contained in the small containers will not escape said small containers and the content of the lower container part is identified more precisely.

2. A container according to claim 1 characterised in that the upper lid surface layer and/or lower lid surface layer is substantially plane.

3. A container according to claim 1 characterised in that the mutual distance between the upper lid surface layer and lower lid surface layer is less than 40 mm, or less than 20 mm, or less than 5 mm, or the mutual distance is 0.5 mm.

4. A container according to claim 1 characterised in that the upper or lower lid surface layer is structured, whereby two or more sub-cavities are defined between said layers.

5. A container according to claim 4 characterised in that the two or more sub-cavities are of similar shape and size.

6. A container according to claim 1 characterised in that the lid cavity comprises a means for holding an item contained in the lid cavity.

7. A container according to claim 1 characterised in that the upper lid surface layer is pivotally connected to the lower lid surface layer.

8. A container according to claim 1 characterised in that the upper lid surface layer is connected to the lower lid surface layer by way of a means arranged for translation, such as sliding, of the upper lid surface layer relative to the lower lid surface layer, or vice versa.

9. A container according to claim 1 characterised in that the upper lid part is pivotally connected to the lower container part, and in that said connection between the upper lid part and the lower container part is arranged adjacent to said connection between the upper and lower lid surface layer.

10. A container according to claim 1 characterised in that the upper and lower lid surface layers comprise a connection to adapted the upper and lower lid surface layers to each other.

11. A container according to claim 1 characterised in that the upper and lower lid surface layers comprise a release arranged for releasing the upper and lower lid surface layers from each other.

12. A container according to claim 11 characterised in that the release means is pressure-activated.

13. A container according to claim 1 characterised in that the container is an assortment box for carrying tool assortment, such as nails, screws, electronic components or the like.
